(19) United States
(12) Patent Application Publication
(10) Pub. No.: US 2023/0043997 A1
(43) Pub. Date: Feb. 9, 2023

(54) COMPOSITE MEMBRANE WITH NANOSELECTIVE SURFACE FOR ORGANIC SOLVENT NANOFILTRATION

(71) Applicant: W. L. Gore & Associates, Inc., Newark, DE (US)

(72) Inventors: Gary Harp, Newark, DE (US); Scott Zero, Newark, DE (US)

(21) Appl. No.: 17/758,351

(22) PCT Filed: Sep. 21, 2020
(86) PCT No.: PCT/US2020/051762

§ 371 Date: Jul. 1, 2022

Related U.S. Application Data
(60) Provisional application No. 62/962,233, filed on Jan. 17, 2020.

(51) Int. Cl. B01D 71/34; B01D 71/36; B01D 71/60; B01D 69/12

(52) U.S. Cl. CPC B01D 71/34; B01D 71/36; B01D 71/601; B01D 69/12

(57) ABSTRACT

Organic solvent nanofiltration membranes that include at least one polymer coated expanded polyparaxylylene (eP-PX) membrane are provided. A substrate/support layer may be positioned on one side of the ePPX membrane. In some embodiments, the substrate/support layer is sandwiched between ePPX membranes. Processes for manufacturing and using such organic solvent nanofiltration membranes are also provided. The organic solvent nanofiltration membranes are capable of separating and/or concentrating solutes from a solution comprising a lower molecular weight organic solvent with high permeability. The polymer coated ePPX membranes may also be resistant to chemical attack, resistant to gamma radiation, thermally stable, biocompatible, and strong.

### FIELD

The present invention relates generally to organic solvent nanofiltration, and more specifically to organic solvent nanofiltration membranes that include expanded polyparaxylylene membranes having thereon at least one polymeric coating. Processes for manufacturing and using expanded polyparaxylylene organic solvent nanofiltration membranes are also provided.

### BACKGROUND

Organic synthesis in the chemical and pharmaceutical industry is frequently performed in an organic solvent. Separation of the soluble product(s) from the organic solvent is often energy intensive and a significant portion of the total cost of production (Marchetti et al., Chem. Rev. 114:10735-10806 (2014)). Organic solvent nanofiltration (OSN) is a versatile technology that is becoming an attractive alternative to traditional separation and purification techniques, such as distillation.

Nanofiltration is a membrane process that utilizes membranes whose pores are generally in the range of 0.1 nm-5 nm, preferably 0.5 nm-5 nm, and which have molecular weight cut-offs (MWCO) in the region of 200-2000 Da. MWCO of a membrane is generally defined as the molecular weight of a molecule that would exhibit a rejection of at least 90% when subjected to nanofiltration by the membrane. Nanofiltration has been widely applied to filtration of aqueous fluids, but due to a lack of suitable solvent stable membranes has been limited in application to the separation of solutes in organic solvents (i.e. organic solvent nanofiltration). OSN has many potential applications in the manufacturing industry, including solvent exchange, catalyst recovery and recycling, purifications, and concentrations. OSN membranes have been known since the 1980s. In spite of this, there is still a very limited number of commercial membranes available on the market, with the majority of them based on crosslinked or non-crosslinked polyimide materials (PI). Cross-linking of PI OSN membranes increases their solvent resistance and can offer long-term stability in some polar aprotic solvents including acetone, tetrahydrofuran, and dimethylformamide. However, such membranes are often unsuitable for use in chlorinated solvents, strong amines, strong acids, or strong bases. Moreover, the recommended maximum operational temperature for such membranes is only 50° C., which poses serious limitations for implementing OSN in, for example, catalytic processes. Typically, such catalytic reactions are performed at higher temperatures (e.g., 100° C. and above) in aggressive solvents (e.g. dimethylformamide (DMF)), and at high concentrations of strong acid or strong base, meaning that only the most stable OSN membranes will be suitable. While ceramic membranes have been shown to possess higher tolerances towards organic solvents and elevated temperatures, their suitability is hampered by their brittle structure, as well as processing difficulties, which make it difficult to achieve the desired nanofiltration characteristics. Furthermore, some larger scale industrial processes OSN separations use modules that include hollow fiber or spiral wound membrane cartridges to provide a high surface area. These modules are typically pressurized to high differential pressures from 5 to 100 bar. These high pressures further exacerbate difficulties faced by conventional membranes due to their poor chemical, solvent, mechanical and temperature stability.

Porous polytetrafluoroethylene (PTFE) has been used as filter media for separating relatively large nanoparticles (e.g., from about 20 nanometers (nm) to about 100 nm) from liquid media, such as, for example, for preparing ultrapure water for use in the semiconductor and pharmaceutical industries. The porous PTFE may be in an expanded form, often referred to as expanded polytetrafluoroethylene (ePTFE), which has a node and fibril microstructure that provides a highly porous network that may be made with a small average pore size for relatively large nanoparticle filtration. However, ePTFE membranes suitable for effective use in organic solvent nanofiltration have not been identified.

There exists a need in the art for organic solvent nanofiltration membranes and methods to make such membranes.

### SUMMARY

According to one Aspect (“Aspect 1”), an organic solvent nanofiltration (OSN) membrane includes at least one expanded polyparaxylylene (ePPX) membrane having at least one polymer coating thereon where the ePPX membrane has a microstructure including nodes, fibrils and pores, the nodes being interconnected by said fibrils and said pores being a void space between said nodes and fibrils and where the ePPX membrane has an average pore size of about 0.1 nm to about 5 nm.

According to another Aspect (“Aspect 2”) further to Aspect 1, the polymer coating is on one or both sides of the ePPX membrane.

According to another Aspect (“Aspect 3”) further to Aspects 1 and 2, the nodes and fibrils are at least partially coated with said polymer coating.

According to another Aspect (“Aspect 4”) further to any of the preceding Aspects, the polymer coating is cross-linked.

According to another Aspect (“Aspect 5”) further to any of the preceding Aspects, the at least one polymer coating includes polyethyleneimine (PEI), branched polyethyleneimine (BPEI), polyvinyl alcohol (PVA), polyvinylidene difluoride (PVDF), an amorphous perfluoropolymer, fluorinated ethylene propylene (FEP), and combinations thereof.

According to another Aspect (“Aspect 6”) further to any of the preceding Aspects, the at least one polymer coating is a cross-linked polymer coating.

According to another Aspect (“Aspect 7”) further to any of the preceding Aspects, the at least one expanded ePPX membrane is a composite ePPX membrane where the composite ePPX membrane including the ePPX membrane is coupled to at least one side to at least one additional porous substrate.

According to another Aspect (“Aspect 8”) further to any of the preceding Aspects, the additional porous substrate is a porous polyolefin.

According to another Aspect (“Aspect 9”) further to any of the preceding Aspects, the additional porous substrate includes polytetrafluoroethylene (PTFE), modified PTFE, or a non-melt processible copolymer or terpolymer including tetrafluoroethylene (TFE).

According to another Aspect (“Aspect 10”) further to any of the preceding Aspects, the additional porous substrate is an expanded PTFE (ePTFE) membrane.

According to another Aspect (“Aspect 11”) further to any of the preceding Aspects, the organic solvent nanofiltration membrane is a polymer coated ePPX-ePTFE composite membrane.

According to another Aspect (“Aspect 12”) further to any of the preceding Aspects, the at least one polymer coating is not polyparaxylylene.

According to another Aspect (“Aspect 13”) further to any of the preceding Aspects, the ePPX membrane includes a polyparaxylylene polymer selected from PPX-N, PPX-AF4, PPX-VT4, or any combination thereof.

According to another Aspect (“Aspect 14”) further to any of the preceding Aspects, further comprising at least one porous support.

According to another Aspect (“Aspect 15”) further to any of the preceding Aspects, the porous support is a stainless steel mesh, a membrane, a woven or a non-woven made of a cross-linked polyimide, a polyamide, polybenzimidazole (PBI), PTFE, cross-linked polyvinylchloride (PVC), polybutylene terephthalate (PBT), polyethylene terephthalate (PET), polyether ether ketone (PEEK), a polyaramide, inorganic silica, or any combination of copolymer thereof.

According to another Aspect (“Aspect 16”) a system includes (1) the organic solvent nanofiltration membrane of any preceding Aspect and (2) a solution to be passed through (a) comprising at least one solute having a first molecular weight and at least one organic solvent having a second molecular weight, and where the second molecular weight is less than the first molecular weight.

According to another Aspect (“Aspect 17”) further to Aspect 16, the solute is a pharmaceutical molecule, a petrochemical molecule, a plant extract, a vegetable oil, an animal extract, a cellular extract, a protein, an enzyme, a lipid, an organic catalyst or an inorganic catalyst.

According to another Aspect (“Aspect 18”), an article includes the organic solvent nanofiltration membrane of any preceding Aspect.

According to another Aspect (“Aspect 19”), a filtration device includes (1) a filtration housing that includes at least one fluid inlet configured to direct a feed fluid into the filtration housing and at least one fluid outlet configured to direct a filtrate from the filtration housing, and (2) at least one organic solvent nanofiltration membrane of any previous Aspect.

According to another Aspect (“Aspect 20”), a method for organic solvent nanofiltration includes (1) providing a filtration housing as disclosed in Aspect 18 and a solution comprising at least one solute having a first molecular weight and at least one organic solvent having a second molecular weight and (2) passing the solution through the filtration device where the percent rejection of the solute is at least 40%, 50%, 60%, 70%, 80%, 90%, 95%, 98% or 99%.

According to another Aspect (“Aspect 21”) further to Aspect 20, the solute is a pharmaceutical molecule, a petrochemical molecule, a plant extract, a vegetable oil, an animal extract, a cellular extract, a protein, an enzyme, a lipid, an organic catalyst or an inorganic catalyst.

According to another Aspect (“Aspect 22”) further to Aspect 20 or 21, the first molecular weight is at least 150 g/mol, preferably 150 g/mol to 2500 g/mol.

According to another Aspect (“Aspect 23”) further to Aspect 20 or 21, the second molecular weight is 450 g/mol or less, preferably less than 250 g/mol, and most preferably less an 100 g/mol.

According to another Aspect (“Aspect 24”) further to Aspect 20 or 21, the first molecular weight is greater than said second molecular weight by at least 100 g/mol, preferably at least 250 g/mol, and most preferably at least 500 g/mol.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an elevational view of a filtration device with an organic solvent nanofiltration membrane in accordance with some embodiments;

FIG. 2 is a schematic view of the system used to apply a polymer coating to an expanded polyparaxylylene (ePPX) membrane in accordance with some embodiments;

FIG. 3 is a schematic of the nanofilter stir cell test apparatus in accordance with some embodiments;

FIG. 4 is a flow chart illustrating the organic solvent nanofiltration process in accordance with some embodiments;

FIG. 5 is a scanning electron micrograph (SEM) of an organic solvent nanofiltration membrane prepared as described in Example 6 in accordance with some embodiments; and

FIG. 6 is an SEM of an organic solvent nanofiltration membrane prepared as described in Example 7 in accordance with some embodiments.

### GLOSSARY

The term “PPX” refers to polyparaxylylene or Parylene.

The term “PPX polymer” is meant to include all forms of PPX, including, but not limited to, those set forth in Table 1 and combinations thereof.

TABLE 1
PPX Polymer Forms

| Form | Structure |
|---|---|
| PPX-N | 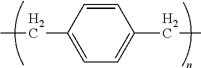 |
| PPX-AF4 | 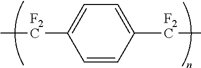 |
| PPX-VT4 | 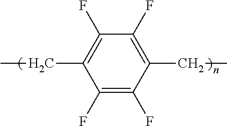 |
| PPX-C | 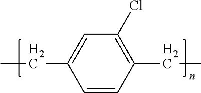 |
| PPX-D | 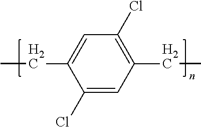 |

The term “PPX polymer film” as used herein is meant to denote unexpanded PPX polymer, either in a freestanding configuration without an underlying substrate or in a composite configuration on one or more sides of a substrate (e.g., PPX polymer film/substrate, PPX polymer film/substrate/PPX polymer film).

The terms “PPX polymer membrane” or “expanded PPX membrane” or “ePPX membrane” as used herein is meant to denote a PPX polymer film that has been expanded in one or more directions and comprises a node and fibril microstructure having pores.

As used herein, the terms “polymer coated ePPX membrane”, “ePPX membrane having at least one polymer coating”, and “coated ePPX membrane” refers to ePPX membranes having an applied polymeric coating that partially occludes and reduces the average pore size to an average pore size range suitable for organic solvent nanofiltration, or alternatively increases solute rejection for solutes with molecular solution dimensions below 5 nm, such as from 0.5 nm to 2 nm. The ePPX membrane may in a composite configuration with another porous expanded polymer membrane (referred to herein as a “composite ePPX membrane”), such as an ePTFE membrane, prior to application of the polymer coating that partially occludes and reduces the average pore size to a range suitable for organic solvent nanofiltration.

The terms “composite polymer coated ePPX membrane” and “organic solvent nanofiltration membrane” refer to a composite ePPX membrane (i.e., ePPX membrane with at least one additional expanded polymer membrane substrate/support layer that may have a node and fibril microstructure(such as an ePTFE membrane)), where the composite ePPX membrane is coated with at least one polymer that partially occludes, and therefore reduces, the average pore size of the composite ePPX membrane.

As used herein, the terms “biaxial” or “biaxially oriented” are meant to describe a polymer, membrane, preform, or article that is expanded in at least two directions, either simultaneously or sequentially. The ratio of the matrix tensile strength (MTS) in two orthogonal directions (i.e., longitudinal/machine vs. transverse; x/y planes) may be used to describe the relative “balance” of a biaxially oriented membrane. Balanced membranes typically exhibit MTS ratios of about 2:1 or less.

As used herein, the phrase “partially occludes the pores” refers to the application of a polymeric coating to the porous ePPX membrane (or ePPX composite membrane) that effectively reduces the average pore size to a range that is suitable for organic solvent nanofiltration applications. The amount of applied polymeric coating is controlled so that it does not fully occlude (completely obstruct/block) the pores of the ePPX membrane as the resulting composite would not be suitable for organic solvent nanofiltration applications. The type of polymer coating as well as the relative thickness of the coating can be adjusted to adjust/tune the organic solvent nanofiltration performance (e.g., permeance/flux, percent solute rejection, concentration factor, or any combination thereof).

The term “organic solvent nanofiltration” or “OSN” refers to a filtration process using at least one nanoporous membrane to separate and/or concentration one or more bulky solutes (i.e., solutes having a molecular weight greater than about 150 g/mol, greater than about 300 g/mol, greater than about 500 g/mol; from about 150 to about 2500 g/mol; from about 300 to about 2500 g/mol) from a lower molecular weight organic solvent (i.e., the organic solvent(s) typically no more than 450 g/mol; no more than 250 g/mol, less than 150 g/mol, or 100 g/mol or less). The organic solvent and the solute should have a relative difference in molecular weight such that the ePPX membranes can selectively separate them by size. In one embodiment, the solute has a molecular weight that is higher than the molecular weight of the organic solvent by at least 100 g/mol, at least 250 g/mol, or at least 500 g/mol. Filtration of the organic solution through the OSN membrane will preferentially permit the organic solvent to pass through the membrane (i.e., filtrate/permeate) while the larger solute molecule is concentrated on the retentate side of the membrane. Due to the often harsh filtration conditions (solvent, temperature, pressure, ultraviolet light, etc.) it is desirable to use a membrane that is thin, strong, chemically inert, and/or thermally stable.

As used herein, the term “thin” is meant to describe a thickness of less than about 50 microns.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting. It is to be appreciated that the terms “OSN” and “organic solvent nanofiltration” may be used interchangeably herein. It is also to be appreciated that the terms “substrate/support layer” and “support later” may be used interchangeably herein. It is to be further appreciated that in this disclosure, an occluding coating may not strictly separate based on pore size. For example, the occluding layer may be “non-porous” in the pores (e.g., totally occluded) and may separate by solution diffusion.

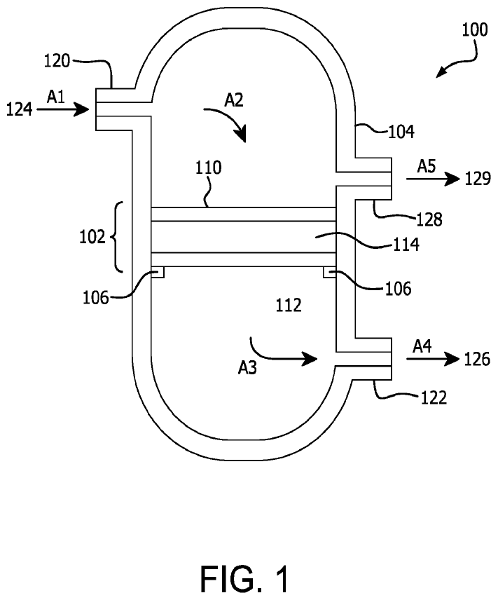

Referring initially to FIG. 1, an embodiment of an organic solvent nanofiltration (OSN) device 100 is shown with an OSN membrane 102 disposed within an internal volume of a filtration housing 104. The OSN membrane 102 includes a porous expanded polyparaxylylene (ePPX) polymer membrane having thereon at least one polymeric coating. The illustrative OSN membrane 102 includes a first polymer coated ePPX membrane 110, a second polymer coated ePPX membrane 112, and an intermediate substrate/support layer 114. In some embodiments, the intermediate layer is a polymer membrane having a node and fibril microstructure such as, but not limited to, an ePTFE membrane. It is to be appreciated that in some embodiments, the substrate/support layer is porous, but may not have a node and fibril microstructure. Alternatively, the OSN membrane 102 may have a composite configuration that includes a composite polymer coated ePPX membrane layer 110, a composite polymer coated ePPX membrane layer 112 (which may be the same as or different from the composite polymer coated ePPX membrane layer 110), and an intermediate substrate/support layer 114. As one example, the organic solvent nanofiltration membrane 102 may be disc-shaped; however, the size and shape of the organic solvent nanofiltration membrane 102 may vary to fit within a desired filtration housing 104 and/or to accommodate an intended organic solvent nanofiltration application. For example, the organic solvent nanofiltration membrane 102 may have a cylindrical shape, a pleated cartridge shape, a spiral-wound shape, or another suitable shape.

The filtration housing 104 has at least one fluid inlet port 120 in fluid communication with the polymer coated ePPX membrane layer 110 and at least one fluid outlet port 122 in fluid communication with the polymer coated ePPX membrane layer 112. The filtration housing 104 also includes one or more support structures, such as an annular shelf 106, configured to support the OSN membrane 102 in the filtration housing 104 between the fluid inlet port 120 and the fluid outlet port 122.

During operation of the fluid filtration device 100, a feed fluid 124 containing a solution having therein at least one solute in an organic solvent is fed into the filtration housing 104 through the fluid inlet port 120 in the direction designated by arrow A1. The feed fluid 124 may include at least one organic solvent or a blend or one or more organic solvents. The feed fluid 124 may be used in the pharmaceutical, microelectronics, chemical, and/or food industries. In certain embodiments, the feed fluid 124 may be a concentrated. The solute(s) in the feed fluid 124 will be bulkier and will have a molecular weight larger than the organic solvent. In use, the feed fluid 124 travels through the housing 104 toward the OSN membrane 102 in the direction designated by arrow A2. The OSN membrane 102 separates (at least partially) the solute from the feed fluid 124, and a filtrate/permeate that includes the organic solvent 126 travels through the housing 104 in the direction designated by arrow A3 and is removed from the filtration housing 104 through the fluid outlet port 122 in the direction designated by arrow A4. In certain embodiments, the filtration device 100 includes a second fluid outlet port 128 that removes a retentate 129 in the direction designated by arrow A5, as shown in FIG. 1. In other embodiments, the filtration device 100 lacks the second fluid outlet port 128, and the retained solute(s) remain on or in the organic solvent nanofiltration membrane 102.

Each polymer coated ePPX membrane 110, 112 of OSN membrane 102 has a node and fibril microstructure. In at least one embodiment, the fibrils in one or both of the polymer coated ePPX membranes 110, 112 contain PPX polymer chains oriented along the fibril axis.

As shown in FIG. 1, the organic solvent nanofiltration membrane 102 has two polymer coated ePPX membranes 110, 112 on either side of the substrate/support layer 114. However, it is within the scope of the present disclosure for the OSN membrane 102 to include a single polymer coated ePPX membrane layer on only one side of the substrate/support layer 114. It is also within the scope of the present disclosure for the OSN membrane 102 to include more than two polymer coated ePPX membrane layers.

The substrate/support layer 114 of the organic solvent filtration membrane 102 is not particularly limiting so long as the substrate/support layer 114 is dimensionally stable. If desired, the substrate/support layer 114 may be removable from the polymer coated ePPX membrane layers 110, 112. If the substrate/support layer 114 is not removed from the polymer coated ePPX membrane layers 110, 112 and remains as part of the composite filtration membrane 102, the substrate/support layer 114 should be porous so that the feed fluid 124 is able to pass through the pores of the substrate 114. Non-limiting examples of suitable porous materials for the substrate/support layer 114 include a stainless steel mesh, a membrane, an ultrafilter, a nanofilter, a woven or a non-woven material made of a cross-linked polyimide, a polyamide-imide, a polyamide, glass, zinc, polybenzimidazole (PBI), PTFE, cross-linked polyvinylchloride (PVC), polybutylene terephthalate (PBT), polyethylene terephthalate (PET), polyether ether ketone (PEEK), a polyaramide, inorganic silica, or any combination of copolymer thereof. In some embodiments, the substrate/support layer 114 is capable of substantial deformation in one or more directions, and may be formed of a partially expanded ePTFE tape or membrane. The organic solvent nanofiltration membrane 102 of FIG. 1 has a single substrate/support layer 114, but it is also within the scope of the present disclosure for filtration membrane 102 to include multiple substrates/support layers.

Various properties of each polymer coated ePPX membrane 110, 112 and/or the substrate/support layer 114 of the filtration membrane 102 may be optimized to achieve a desired filtration performance with a desired permeability for the particular solute(s) being separated from the feed fluid 124. Properties that may be optimized include, for example, thickness, average pore size, percent porosity, the type of polymer coating, and the polymer coating thickness, as discussed in the following paragraphs. Other properties that may be optimized include, for example, node and/or fibril geometry or size and density of the ePPX membrane.

As discussed above, the thicknesses of the polymer coated ePPX membranes 110, 112 and the substrate/support layer 114 may be optimized for a desired application. Each polymer coated ePPX membrane 110, 112 of the organic solvent nanofiltration membrane 102 may have a nominal thickness less than about 50 microns, less than about 40 microns, less than about 30 microns, less than about 20 microns, less than about 10 microns, less than about 5 microns, less than about 3 microns, less than about 2 microns, or less than about 1 micron. In some embodiments, each polymer coated ePPX membrane 110, 112 has a thickness from about 0.1 microns to about 50 microns, from about 0.1 microns to about 40 microns, from about 0.1 microns to about 30 microns, from about 0.1 microns to about 20 microns, from about 0.1 microns to about 10 microns, from about 0.1 microns to about 5 microns, from about 0.1 microns to about 3 microns, from about 0.1 microns to about 2 microns, or from about 0.1 microns to about 1 micron. By comparison, the substrate/support layer 114 of the organic solvent nanofiltration membrane 102 may be relatively thick (e.g., thicker than about 50 microns).

In addition, the porosities of the polymer coated ePPX membranes 110, 112 and the substrate/support layer 114 may be optimized. Each polymer coated ePPX membrane 110, 112 of the organic solvent nanofiltration membrane 102 may have relatively small pore sizes of less than about 3 nanometers (nm), less than about 2 nm, less than about 1 nm or less than about 0.5 nm. In some embodiments, each polymer coated ePPX membrane 110, 112 may have pores from about 0.01 nm to about 5 nm, from about 0.5 nm to about 5 nm, from about 0.5 nm to about 3 nm, from about 0.5 nm to about 2 nm, or from about 0.5 nm to about 1 nm. Also, each polymer coated ePPX membrane 110, 112 may have a percent porosity of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or up to (and including) about 95%.

The organic solvent nanofiltration membrane 102 may have one or more different microstructures. In at least one embodiment, the polymer coated ePPX membranes 110, 112 share the same microstructure or substantially the same microstructure such that the microstructures cannot be distinguished from each other. In another embodiment, the polymer coated ePPX membrane 110 has a first microstructure and the polymer coated ePPX membrane 112 has a second microstructure that is different from the first microstructure. The difference between the various microstructures of the polymer coated ePPX membranes 110, 112 can be measured by, for example, a difference in porosity, a difference in node and/or fibril geometry or size, and/or a difference in density.

Referring still to FIG. 1, the small pores in the polymer coated ePPX polymer membranes 110, 112 may allow the organic solvent nanofiltration membrane 102 to separate and retain solutes of various types and sizes, so long as the solute is bulkier/larger than the organic solvent. In certain embodiments, such as when separating relatively large solutes from the feed fluid 124, the organic solvent nanofiltration membrane 102 may achieve solute retention of about 40% or more, about 60% or more, about 80% or more, or about 90% or more with each pass. The organic solvent filtration membrane 102 may achieve different degrees of filtration depending on the size of the pores in the PPX polymer membranes 110, 112.

In addition, the thin construction of the polymer coated ePPX membranes 110, 112 and/or the comparatively large pores in the substrate/support layer 114 create a highly permeable (i.e., low resistance to flow) organic solvent nanofiltration membrane 102 that accommodates high flow rates of the feed fluid 124 at a given pressure. For example, the organic solvent nanofiltration membrane 102 may have a permeability of at least about 100 LMH/bar, at least about 20 LMH/bar, at least about 10 LMH/bar, at least about 1 LMH/bar, or at least about 0.5 LMH/bar. The organic solvent nanofiltration membrane 102 may also be resistant to chemical attack, resistant to gamma radiation, thermally stable, biocompatible, strong, or any combination thereof.

The organic solvent nanofiltration membrane 102 may also include one more support layers/backers depending upon the application. Examples of suitable supports/backers may include membranes, ultrafilters, nanofilters, wovens or non-wovens made of materials such as cross-linked polyimides, polytetrafluoroethylene (PTFE), expanded PTFE (ePTFE), cross-linked polyvinylchloride (PVC), polybutylene terephthalate (PBT), polyethylene terephthalate (PET), polyether ether ketone (PEEK), aramids (such as KEVLAR®), stainless steel mesh, inorganic silica membranes or any combination thereof.

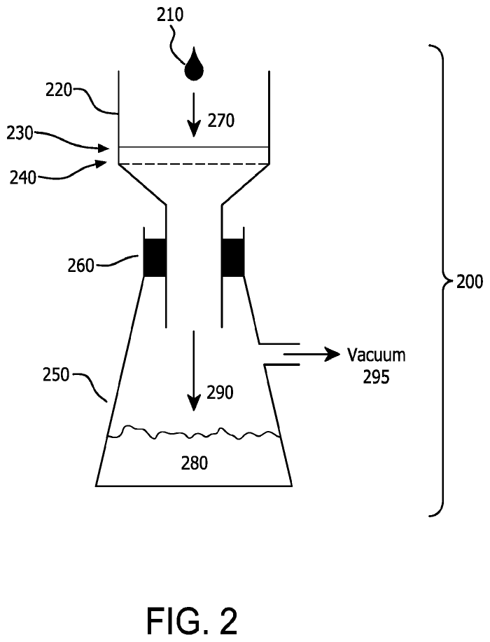

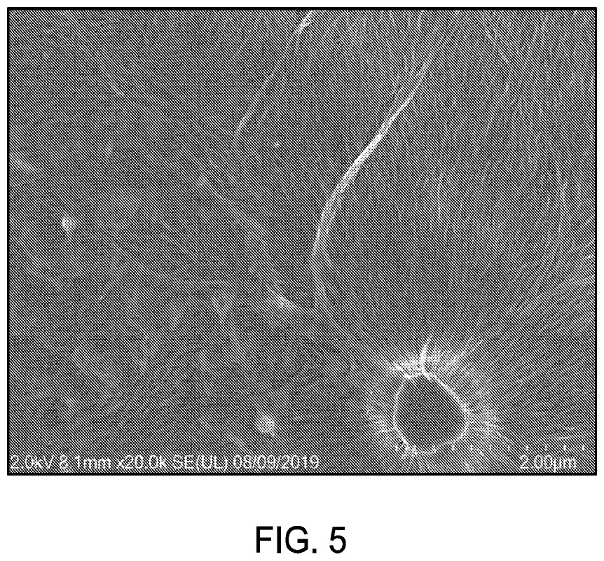

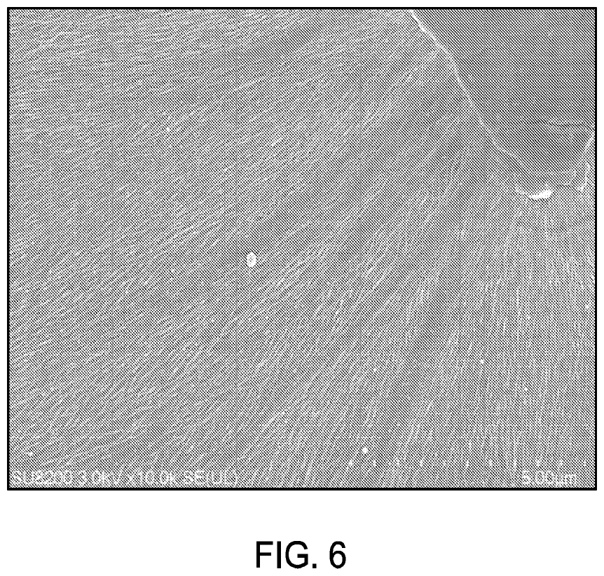

Referring now to FIG. 2, a method (200) for applying a polymer coating to an ePPX membrane is illustrated. A solution (210) that includes the dissolved polymer is placed in contact (270) with the (hooped and supported) ePPX membrane (230) placed on top of a support/substrate (240) within a glass funnel (220). A vacuum (295) applied to a Büchner flask (250) pulls the coating solution (210) through the supported ePPX membrane (230) and collects the excess coating solution (290) in the bottom of the flask (280). A rubber bung (260) may be used to hold the glass funnel (220) on top of the flask (250). Scanning electron micrographs (SEMs) of exemplary organic solvent nanofiltration membranes are provided as FIGS. 5 and 6.

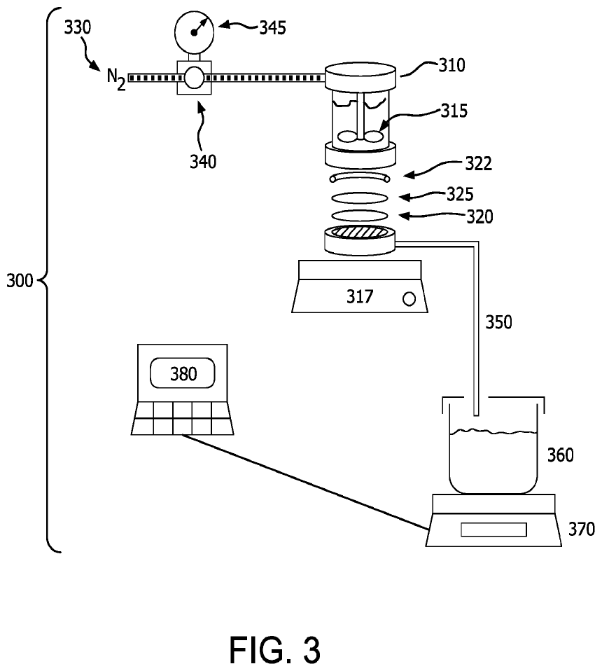

FIG. 3 is an illustration of a system (300) used to measure membrane performance that includes a pressurized nanofiltration (NF) stir cell (Millipore/Amicon 8050) apparatus (310) with a magnetic stirrer (315) and a magnetic stir-plate (317). In FIG. 3, the organic solvent nanofiltration membrane (325) is mounted adjacent to an o-ring (322) and sealed to the base of the stir cell per the manufacturer's instructions using a gasket with nonwoven support disks (320) to enhance flow distribution. The cell is charged with the challenge solvent/solute, gas pressure is provided by a nitrogen source (330) and is regulated via a pressure regulator (340) to the desired set point pressure read by a pressure gauge (345) to the set pressure for the test. Liquid is pushed through the filter media from the liquid reservoir in the stir cell to the downstream of the filter and out through an outlet port and into a tube (350). The liquid exits the tube and is collected in a reservoir (360) on an electronic scale (370) connected to a computer data acquisition system (380) which records the mass as a function of time.

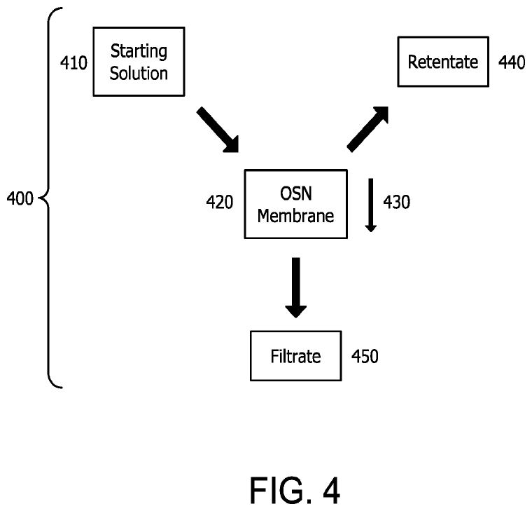

Referring next to FIG. 4, a generic organic solvent nanofiltration process (400) is illustrated where a solution (410) that includes the solute in at least one organic solvent is filtered (430) through the organic solvent nanofiltration membrane (420). The fluid filtrate/permeate that includes the organic solvent (450) is collected. At least a portion of the solute is preferentially retained and concentrated in the retentate (440) side of the OSN membrane (420).

Polymer Coatings Applied to ePPX Membranes

A variety of polymers may be used to coat and partially occlude the pores of the ePPX membranes. Such polymers include, but are not limited to, polyvinylidene difluoride (PVDF), polyvinyl alcohol (PVA), polyethyleneimine (PEI), branched polyethyleneimine (BPEI), an amorphous perfluoropolymer, fluorinated ethylene propylene (FEP), and combinations thereof. In one embodiment, the amount and thickness of the applied polymer coating is adjusted to optimize organic solvent nanofiltration performance (selectivity, permeance, etc.). In another embodiment, the polymer coating may be cross-linked with a suitable cross-linking agent.

The polymer coating may be applied using a variety of technics, such as chemical vapor deposition, atomic layer deposition, sputter coating, solvent coating/imbibing, nanoparticle dispersion coating, and any combination thereof. The polymer coatings may be applied to one side (for example, using a slot die) or both sides (for example, dip coated) of the ePPX membrane. In one embodiment, solvent coating follows the process described in the Examples and as illustrated in FIG. 2.

The thickness of the polymer coating may vary so long as the pores are not fully occluded (i.e., fully blocked to organic solvent flow) yet still facilitates selective separation of the solute(s) from the organic solvent(s). In one embodiment, the thickness of the polymer coating ranges from 100 nm to 5 μm.

The final average pore size range (after coating) is from about 0.1 nm to about 5 nm, from about 0.5 nm to about 3 nm, from about 0.5 nm to about 2 nm, from about 0.5 to about 1.5 nm, or from about 0.5 nm to about 1 nm.

Solutes

The compositions and methods described herein can be used to selectively separate and/or concentration a solute or multiple solutes from a solution that includes at least one organic solvent. In one embodiment, the present organic solvent nanofiltration membranes separate a solute which is relatively larger/bulkier than the corresponding organic solvent(s) within the fluid matrix. In one embodiment, the solute may have molecule weight greater than about 150 g/mol, greater than about 300 g/mol, greater than about 500 g/mol, from about 150 g/mol to about 2500 g/mol, from about 300 g/mol to about 2000 g/mol, from about 500 g/mol to about 1000 g/mol). The corresponding organic solvent(s) may have a molecular weight that is no more than about 450 g/mol; no more than about 250 g/mol, no more than about 150 g/mol, or no more than about 100 g/mol so long as the solute has a molecular weight that is larger than the organic solvent within the fluid matrix.

In one embodiment, the solute is a pharmaceutical ingredient/intermediate, a higher molecular weight/higher boiling petrochemical molecules, food industry molecules such as plant extracts/oils (e.g., vegetable oils), animal extracts (e.g., oils, etc.), cellular extracts (biomolecules, proteins, enzymes, lipids, etc.), monomers, or catalysts, to name a few.

In another embodiment, the polymer coated ePPX membrane may be used to selectively separate multiple solutes from a complex feed stream as might be found in petrochemical refining. For example, the solute may be a crude oil, or a fractional distillate such as binker oil, white oil, or wide cut diesel fuel. Further solutes may include wide or heavy cut hydrocarbons of various aliphatic, olefinic, parrafinic, and naphtalinic species, and the solvent may include a complex mixture of lower boiling linear or cyclic hydrocarbons, such as, for example, in the non-limiting sense including the BTEX series (e.g., benzenes, toluenes, ethylbenzene and xylenes). The polymer coated ePPX membrane may separate these from higher molecular weight compounds or separate within the individual families (e.g., paraxylene from xylene). Further the polymer coated ePPX membrane may accomplish a separation of constituents having different degrees of oxidation state, chirality or other molecular differentiations. Such an example includes dewaxing of a lubricant fluid.

Typically, pressures used for membrane OSN may include from 4 to 200 bar, or from 4 to 60 bar.

Organic Solvents

Table 2 provides a non-limiting list of common organic solvents along with their respective molecular weights and chemical formulas.

TABLE 2

| | | Molecular Weight |
|---|---|---|
| Solvent | Formula | (g/mol) |
| acetic acid | C₂H4O₂ | 60.052 |
| acetone | C₃H₆O | 58.079 |
| acetonitrile | C₂H₃N | 41.052 |
| benzene | C₆H₆ | 78.11 |
| 1-butanol | C₄H₁₀O | 74.12 |
| 2-butanol | C₄H₁₀O | 74.12 |
| 2-butanone | C₄H₈O | 72.11 |
| t-butyl alcohol | C₄H₁₀O | 74.12 |
| carbon tetrachloride | CCl₄ | 153.82 |
| chlorobenzene | C₆H₅Cl | 112.56 |
| chloroform | CHCl₃ | 119.38 |
| cyclohexane | C₆H₁₂ | 84.16 |
| 1,2-dichloroethane | C₂H₄Cl₂ | 98.96 |
| diethylene glycol | C₄H₁₀O₃ | 106.12 |
| diethyl ether | C₄H₁₀O | 74.12 |
| diglyme (diethylene glycol | C₆H₁₄O₃ | 134.17 |
| dimethyl ether) | | |
| 1,2-dimethoxy-ethane | C₄H₁₀O₂ | 90.12 |
| (DME) | | |
| dimethyl-formamide (DMF) | C₃H₇NO | 73.09 |
| dimethyl sulfoxide (DMSO) | C₂H₆OS | 78.13 |
| 1,4-dioxane | C₄H₈O₂ | 88.11 |
| ethanol | C₂H₆O | 46.07 |
| ethyl acetate | C₄H₈O₂ | 88.11 |
| ethylene glycol | C₂H₆O₂ | 62.07 |
| glycerin | C₃H₈O₃ | 92.09 |
| heptane | C₇H₁₆ | 100.2 |
| Hexamethylphosphoramide | C₆H₁₈N₃OP | 179.2 |
| (HMPA) | | |
| Hexamethylphosphorous | C₆H₁₈N₃P | 163.2 |
| triamide (HMPT) | | |
| hexane | C₆H₁₄ | 86.18 |
| methanol | CH₄O | 32.04 |
| methyl t-butyl ether (MTBE) | C₅H₁₂O | 88.15 |
| methylene chloride | CH₂Cl₂ | 84.93 |
| N-methyl-2-pyrrolidinone | CH₅H₉NO | 99.13 |
| (NMP) | | |
| nitromethane | CH₃NO₂ | 61.04 |
| pentane | C₅H₁₂ | 72.15 |
| 1-propanol | C₃H₈O | 60.1 |
| 2-propanol | C₃H₈O | 60.1 |
| pyridine | C₅H₅N | 79.1 |
| tetrahydrofuran (THF) | C₄H₈O | 72.106 |
| toluene | C₇H₈ | 92.14 |
| triethyl amine | C₆H₁₅N | 101.19 |
| o-xylene | C₈H₁₀ | 106.17 |
| m-xylene | C₈H₁₀ | 106.17 |
| p-xylene | C₈H₁₀ | 106.17 |
| HFE-7500 (3-ethoxyl- | C₉H₅F₁₅O | 414.11 |
| 1,1,1,2,3,4,4,5,5,6,6,6- | | |
| dodecafluoro-2- | | |
| trifluoromethyl hexane) | | |

Organic Solvent Nanofiltration Process Conditions

Typical organic solvent nanofiltration (OSN) separations vary widely depending on the application and can use 10's of cm² filter areas in flat discs (for example, in purification of pharmaceuticals or filtering catalysts from pilot stirred tank reactors) to 1000's of m² (for petrochemical industry separations). The membranes utilized preferably exhibit stable rejection of solutes, the ability to concentrate these solutes, and the ability to permeate at relevant rates.

In one embodiment, the percent (%) rejection of solute by the polymer coated ePPX membrane is at least about 40%, about 50%, about 60%, about 70%, about 80%, about 90%, about 95%, about 98% or about 99%. In a further embodiment, the % solute rejection is measured using a differential pressure of 60 psi (˜413.7 kPa) with an effective filter area of 13.4 cm² after at least 75 vol % of the starting solution volume has been collected in the permeate. In addition to the high percent (%) rejection, the polymer coated ePPX membrane also has a permeance of at least about 1, about 5, about 10, about 15, about 20, about 50 or about 100 (liters/m²/hr)/bar.

In another embodiment, the concentration factor (OF; fold increase in solute in the retentate) is at least about 1.1, about 1.25, about 1.5, about 1.75, about 2, about 3, about 4, about 5, about 10, about 25, about 50 or about 100.

Membrane performance may also be characterized by the membrane nominal molecular weight cutoff (MWCO), which is defined as the smallest solute molecular weight for which the membrane has at least 90% rejection. In one embodiment, the MWCO of the polymer coated ePPX is about 300, about 400, about 500, about 600, about 700, about 800, about 900, about 1000, about 1500 or about 2000 Da.

### TEST METHODS

It should be understood that although certain methods and equipment are described below, other methods or equipment determined suitable by one of ordinary skill in the art may be alternatively utilized.

Thickness

Sample thickness was measured using a Keyence LS-7010M digital micrometer (Keyence Corporation, Mechelen, Belgium).

Mass per Area (Mass/Area)

The mass/area of the membrane was calculated by measuring the mass of a well-defined area of the membrane sample using a scale. The sample was cut to a defined area using a die or any precise cutting instrument.

Density

The density was calculated by dividing the Mass per Area by Thickness.

Measuring Organic Solvent Nanofiltration Performance Using Rose Bengal Dye

An organic solution comprising Rose Bengal dye (4,5,6,7-tetrachloro-2′,4′,5′,7′-tetraiodofluorescein disodium salt; CAS 632-69-9; MW 1017.64 g/mol) was used to measure the nanofiltration performance of the various polymer coated expanded polyparaxylylene membranes (ePPX). Preparation of the polymer coated ePPX membranes is described in U.S. Patent Publication No. US 2016/0032069 to Sbriglia. The coated ePPX—PTFE membrane samples were die cut to the appropriate size, mounted on top of a non-woven in an AMICON® stirred cell concentrator/separator (Merck KGaA, DarmStadt, Germany), and tested for solvent nanofiltration performance using a Rose Bengal dye solution. The amount of Rose Bengal dye rejection was recorded and the average ethanol—Rose Bengal dye permeance was measured. Tests were conducted with a constant nitrogen pressure of 60 psi [˜413.7 kPa]), the cell was charged with 20 mL of Rose Bengal dye solution at a concentration of 5 mg/L, and 15 mL of fluid was collected as permeate at the end of test unless otherwise noted.

Permeance in LMH/bar ((liters/meters²/hour)/bar) was recorded. As used herein, the term “permeance” is defined as a measure of the degree to which a material allows a fluid to permeate it and is calculated as the filtration flux divided by the test pressure. As used herein, “filtration flux” is defined as the volumetric flow rate in liters/hour divided by the effective filtration area. The volumetric flow rate (L/hr) was determined by measuring the mass of liquid filtered via collection on a calibrated scale and converting this to volume using the density of ethanol (˜0.8 g/cm³ at 20° C.) and then dividing by the filtration time. The filtration time was determined via electronic logging using a data logger Pendotech (PendoTECH, Princeton, N.J.) with a computer or recording the time of filtration with a stopwatch. The effective filter area was determined to be 13.4 cm² as specified by the stir cell manufacturer for Millipore/Amicon 8050 stir cell (Merck KGaA, supra). The pressure was determined using a pressure gauge.

Organic solvent nanofiltration membranes are capable of efficiently separating solute molecular species, such as Rose Bengal dye, from organic solvent feed streams, such as ethanol. One measure of separation efficiency is to calculate a percent rejection, which is given based on the concentration of the solute downstream (Csolute_{down}) of the filter divided by the concentration of the solute upstream (Csoluteᵤₚₛₜᵣₑₐₘ) of the filter minus 1×100 (Equation 1).

Percent Rejection=((Csolute_{down}/Csoluteᵤₚₛₜᵣₑₐₘ)−1)×100 Equation 1

In practice, effective industrial processes require efficient separation membranes capable of solute percent rejections from solvent of at least 60%, more preferably at least 80%, and most preferably at least 90%. Further, in many industrial settings it is desirable to both separate and concentrate the solute. Concentrating a solute may be accomplished by varying the stage cut in a recirculated crossflow system or in a dead end stir cell as used herein. In cases of concentration, it is often useful to calculate a concentration factor where the concentration factor CF is given as the ratio of the Csoluteᵢₙᵢₜᵢₐₗ₍ᵤₚₛₜᵣₑₐₘ₎/Csolute_{final(upstream)} in the retentate (Equation 2).

CF=Csoluteᵢₙᵢₜᵢₐₗ₍ᵤₚₛₜᵣₑₐₘ₎/Csolute_{final(upstream)} Equation 2

In the case of the dead end stir cell used for the examples herein, the CF=Csolute_{final(upstream)}/Csoluteᵢₙᵢₜᵢₐₗ₍ᵤₚₛₜᵣₑₐₘ₎ where “initial” denotes the input at time =0, and the “final” denotes the concentration at the end of the test after permeation of a finite volume. For example, it may be desirable to increase the concentration of a dilute molecule to a useful concentration for application to a concentration factor of at least 1.5×, preferably at least 2×, more preferably greater than 3×.

Rose Bengal dye concentration was determined analytically using spectrophotometry as has been described in the literature (Linden, S. M. and D. C. Neckers, “Type I and type II sensitizers based on Rose Bengal onium salts.” Photochem. Photobiol. 47, 543-550 (1988)). An Agilent Cary UV-vis spectrophotometer (Agilent Technologies Inc., Santa Clara, Calif.) was used with quartz cuvettes. A Beer's law calibration curve was created by serial dilution of the dye in ethanol using peak absorbance at 560 nm. Permeate samples were then collected and diluted if necessary to calculate the solution concentration via comparison of their measured absorbance to the Beer's law curve.

### EXAMPLES

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

### Example 1 (Comparative)

### Expanded Polyparaxylylene (ePPX) Membrane—No Additional Polymer Coating

Using the methodology described in U.S. Patent Publication No. US 2016/0032069 to Sbriglia, a film of polyparaxylylene (PPX-AF4) having a nominal thickness of 1 μm was deposited onto both sides of a blended, extruded, and dried PTFE tape made generally in accordance with the teachings of U.S. Pat. No. 3,953,566 to Gore by a commercially available vapor deposition process (Specialty Coating Systems, 7645 Woodland Drive, Indianapolis, Ind. 46278). The coated article was then cut to dimensions of 200 mm×200 mm and placed in the grips of a pantograph type biaxial batch expander equipped with a convection oven. The coated article (tape) was subjected to a constant temperature of 350° C. for 300 seconds. The coated tape was then simultaneously stretched at an engineering strain rate (ESR) of 100 percent (%)/second to an extension ratio in the tape machine direction (MD) of 4:1 and 4:1 in the tape transverse direction (TD). The expanded article (expanded membrane) was cooled to room temperature (˜22° C.) under restraint of the pantograph biaxial expander grips. After cooling, the expanded polyparaxylylene membrane was removed from the expander grips.

The expanded polyparaxylylene membrane had a gas liquid bubble point >250 pounds per square inch (psi) (>1.72 MPa). The expanded polyparaxylylene membrane was die cut and mounted on top of a TYPAR® 3151 polypropylene spunbond nonwoven (Typar Geosynthetics, Roseville, Minn.) in an AMICON® /Millipore Model 8050 stirred cell concentrator/separator (Merck KGaA, DarmStadt, Germany) and tested for solvent nanofiltration performance using a solution of Rose Bengal lactone dye (Santa Cruz Biotechnology, Dallas, Tex.) (4,5,6,7-tetrachloro-2′,4′,5′,7′-tetraiodofluorescein disodium salt; CAS 11121-48-5; MW 1017.62 g/mol) in ethanol. No rejection (0% rejection) of Rose Bengal dye was observed and an average ethanol—Rose Bengal flux of 235 LMH/bar was recorded (Table 3).

### Example 2 (COMPARATIVE)

### Commercial Nanofiltration Membrane

DURAMEM® 500 modified polyimide membrane (Molecular Weight Cut-off (MWCO) 500 Da; Evonik Degussa Corp., Parsipany, N.J.) was die cut and mounted on top of a TYPAR® 3151 polypropylene spunbond nonwoven (Typar Geosynthetics, supra) in an AMICON® stir cell (Merck KGaA, supra), and tested for solvent nanofiltration performance using a solution of Rose Bengal and ethanol prepared as described above. Seventy-five percent (75%) of the feed charge was filtered to a filtrate/permeate. Rejection of Rose Bengal dye was observed (60% rejection) and the average ethanol—Rose Bengal flux of 0.5 LMH/bar was recorded (Table 3).

### Example 3

### Polyvinyl Alcohol (PVA) Coating on Composite Expanded Polyparaxylylene Membrane

Using the methodology described in U.S. Patent Publication No. 2016/0032069 to Sbriglia, a film of PPX-AF4 having a nominal thickness of 1 μm was deposited onto both sides of a blended, extruded, and dried PTFE tape made generally in accordance with the teachings of U.S. Pat. No. 3,953,566 to Gore by a commercially available vapor deposition process (Specialty Coating Systems, supra). The composite ePPX membrane was then cut to dimensions of 200 mm×200 mm and placed in the grips of a pantograph type biaxial batch expander equipped with a convection oven. The composite ePPX membrane was subjected to a constant temperature of 350° C. for 300 seconds. The composite ePPX membrane was then simultaneously stretched at an engineering strain rate (ESR) of 100%/second to an extension ratio in the tape machine direction of 4:1 and 4:1 in the tape transverse direction. The expanded composite ePPX membrane was cooled to room temperature (˜22° C.) under restraint of the pantograph biaxial expander grips. After cooling, the expanded composite ePPX membrane was removed from the expander grips.

The expanded composite ePPX membrane had a gas liquid bubble point >250 psi (>1.72 MPa). The expanded composite ePPX membrane was pre-wet with 10 mL of isopropanol. The pre-wetted expanded composite ePPX membrane was mounted on a filter paper support in a glass vacuum funnel of 90 mm or 150 mm diameter and dosed with 0.69 mg/cm² of coating solution of polyvinyl alcohol polymer USP (MW ˜100,000) (Spectrum Chemical, New Brunswick, N.J.) in water (the polymer had previously been slowly dissolved in reverse osmosis purified water via gentle heating and stirring on a hot plate at a 0.04 molar concentration and then cooled ant diluted to 0.004 molar concentration) in water by methods known in the art. The PVA solution was drawn into the expanded composite ePPX membrane via vacuum at 15 mm hg (˜20 millibar) until no liquid was visible on the surface of the membrane. The composite polymer coated ePPX membrane (organic solvent nanofiltration membrane) was removed from the vacuum funnel, restrained on a hoop, and then air-dried. The dried composite polymer coated ePPX membrane was placed coated side up in an AMICON® stirred cell concentrator/separator (Merck KGaA, supra) and tested for organic solvent nanofiltration performance as described above. Seventy-five percent (75%) of the feed charge was filtered to a filtrate. The concentration factor CF=2.7×, the average rejection was 57, and the average permeance was 15.4 LMH/bar (Table 3).

### Example 4

### Branched Polyethyleneimine (BPEI)—Crosslinked Coating on Composite Expanded Polyparaxylylene Membrane

Using methodology described in U.S. Patent Publication No. 2016/0032069 to Sbriglia, a film of polyparaxylylene (PPX-AF4) having a nominal thickness of 1 μm was deposited onto both sides of a blended, extruded, and dried PTFE tape made generally in accordance with the teachings of U.S. Pat. No. 3,953,566 to Gore by a commercially available vapor deposition process (Specialty Coating Systems, supra). The composite ePPX membrane was then cut to dimensions of 200 mm×200 mm and placed in the grips of a pantograph type biaxial batch expander equipped with a convection oven. The composite ePPX membrane was subjected to a constant temperature of 350° C. for 300 seconds. The composite ePPX membrane was then simultaneously stretched at an engineering strain rate (ESR) of 100%/second to an extension ratio in the tape machine direction of 4:1 and 4:1 in the tape transverse direction. The expanded composite ePPX membrane was allowed to cool to room temperature (˜22° C.) under restraint of the pantograph biaxial expander grips. After cooling, the expanded composite ePPX membrane was removed from the expander grips. The expanded composite ePPX membrane had a gas liquid bubble point >250 psi (>1.72 MPa). The expanded composite ePPX membrane was then pre-wet with 10 mL of isopropanol. The pre-wetted expanded composite ePPX membrane was mounted on a filter paper support in a glass vacuum funnel of 90 mm or 150 mm diameter and dosed with 0.05 mg/cm² of a branched poly(ethyleneimine) (BPEI) coating solution (catalog #181978, Sigma-Aldrich, St. Louis, Mo.).

The branched poly (ethyleneimine) solution was dissolved in isopropanol (Sigma Aldrich, St. Louis, Mo.) by stirring at a concentration of 0.64 mg BPEI/L isopropanol). The BPEI coating solution was drawn into the expanded composite ePPX membrane via vacuum at 15 mm hg (˜20 millibar) until no liquid was visible on the surface of the expanded composite ePPX membrane. The expanded composite ePPX membrane was then contacted with 0.1 g polyfunctional glycidyl glycerol-ether cross-linking solution (Catalog #9221-50 Polysciences Inc, Warrington, Pa.) in 20 mL IPA by vacuum filtration of the solution through the expanded composite ePPX membrane over 1 minute as with the initial coating solution and then rinsed consecutively with 40 mL of IPA and 40 mL of water by consecutive vacuum filtration as during the coating process. The BPEI cross-linked expanded PPX-PTFE membrane (composite polymer coated ePPX membrane) was removed from the vacuum funnel, restrained on a hoop, and then air-dried. The dried PPX-PTFE membrane was placed with the top side that faced the vacuum coating solution face upon an AMICON® stirred cell concentrator/separator (Mark KGaA, supra) and tested for organic solvent nanofiltration performance as described above. Seventy-five percent (75%) of the feed charge was filtered to a filtrate/permeate. The feed concentration increased CF=3.94×, the average rejection was 98%, and the average flux was 23.2 LMH/bar (Table 3).

### Example 5

### Polyvinylidene Difluoride (PVDF) Coating on Expanded PPX Membrane

Using the methodology described in U.S. Patent Publication No. 2016/0032069 to Sbriglia, a film of polyparaxylylene (PPX-AF4) having a nominal thickness of 1 μm was deposited onto both sides of a blended, extruded, and dried PTFE tape made generally in accordance with the teachings of U.S. Pat. No. 3,953,566 to Gore by a commercially available vapor deposition process (Specialty Coating Systems, supra). The composite ePPX membrane (tape) was then cut to dimensions of 200 mm×200 mm and placed in the grips of a pantograph type biaxial batch expander equipped with a convection oven. The composite ePPX membrane was subjected to a constant temperature of 350° C. for 300 seconds. The composite ePPX membrane was then simultaneously stretched at an engineering strain rate (ESR) of 100%/second to an extension ratio in the tape machine direction of 4:1 and 4:1 in the tape transverse direction. The expanded composite ePPX membrane was allowed to cool to room temperature (˜22° C.) under restraint of the pantograph biaxial expander grips. After cooling, the expanded composite ePPX membrane was removed from the expander grips. The expanded composite ePPX membrane had a gas liquid bubble point >250 psi (>1.72 MPa). The expanded composite ePPX membrane was pre-wet with 10 mL of isopropanol. The pre-wetted expanded composite ePPX membrane was mounted on a filter paper support in a glass vacuum funnel of 90 mm or 150 mm diameter and dosed with 0.34 mg/cm² of polyvinylidene difluoride (PVDF) coating solution (Grade 955 from Arkema (Arkema Inc., King of Prussia, Pa.) dissolved dimethylacetamide (DMAc) with heat at 70° C. and was stirred overnight by methods known in the art at 2.2 g/L weight percent. The room temperature PVDF solution was drawn into the expanded composite ePPX membrane pre-wet with 20 mL of acetone via vacuum at 15 mm hg (˜20 millibar) until no liquid was visible on the surface. This was followed by rinses with 20 mL of water and 20 mL of isopropyl alcohol by vacuum filtration under the same pressure differential as the initial coating. The PVDF-coated ePPX-PTFE membrane (composite polymer coated ePPX membrane) was removed from the vacuum funnel, restrained on a hoop, and then air-dried. The dried PVDF-coated ePPX-PTFE membrane was placed face up in an AMICON® stirred cell concentrator/separator (Merck KGaA, supra) and tested for organic solvent nanofiltration performance as described above. Seventy-five percent (75%) of the feed charge was filtered to a filtrate/permeate. The feed concentration increased to a CF=3.7×, the average rejection was 90%, and the average permeance was 24.7 LMH/bar (Table 3).

### Example 6

### CYTOP® Type A Amorphous Perfluoropolymer Coating on Composite Expanded PPX Membrane

Using the methodology described in U.S. Patent Publication No. 2016.-0032069 to Sbriglia, a film of polyparaxylylene (PPX-AF4) having a nominal thickness of 1 μm was deposited onto both sides of a blended, extruded, and dried PTFE tape made generally in accordance with the teachings of U.S. Pat. No. 3,953,566 to Gore by a commercially available vapor deposition process (Specialty Coating Systems, supra). The composite ePPX membrane (tape) was then cut to dimensions of 200 mm×200 mm and placed in the grips of a pantograph type biaxial batch expander equipped with a convection oven. The composite ePPX membrane was subjected to constant temperature of 350° C. for 300 seconds. The composite ePPX membrane was then simultaneously stretched at an engineering strain rate (ESR) of 100%/second to an extension ratio in the tape machine direction of 4:1 and 4:1 in the tape transverse direction. The expanded composite ePPX membrane was allowed to cool to room temperature (˜22° C.) under restraint of the pantograph biaxial expander grips. After cooling, the expanded composite ePPX membrane was removed from the expander grips. The expanded composite ePPX membrane had a gas liquid bubble point >250 psi (>1.72 MPa). The expanded composite ePPX membrane was then pre-wet with 10 mL of isopropanol. The pre-wetted expanded composite ePPX membrane was mounted on a filter paper support in a glass vacuum funnel of 90 mm or 150 mm diameter and dosed with 0.05 mg/cm² of a CYTOP® amorphous perfluoropolymer coating solution (CYTOP® polymer type A; standard molecular weight 250K-300K, AGC Chemicals Americas, Inc., Exton Pa.) dissolved in HFE-7500 (3-ethoxyl-1,1,1,2,3,4,4,5,5,6,6,6-dodecafluoro-2-trifluoromethyl hexane (also known as Novec 7500™; MW=414.1; 3M Corporation, St. Paul, Minn.) by methods known in the art at 0.2 weight percent. The CYTOP® coating solution was drawn into the expanded composite ePPX membrane via vacuum at 15 mm hg (˜20 millibar) until no liquid was visible on the surface. The composite polymer coated ePPX membrane was removed from the vacuum funnel, restrained on a hoop, air dried, and then dried in an oven at 360° C. for ten minutes. The dried CYTOP® coated composite ePPX membrane was placed face up in an AMICON® stirred cell concentrator/separator (Merck KGaA, supra) and tested for organic solvent nanofiltration performance as described above. Seventy-five percent (75%) of the feed charge was filtered to a filtrate/permeate. The feed concentration increased CF=3.6×, the average rejection was 88%, and the average permeance was 100 LMH/bar. FIG. 5 is a scanning electron micrograph (SEM) of the CYTOP® coated expanded composite ePPX membrane.

### Example 7

### Fluorinated Ethylene Propylene (FEP) Coating on Composite Expanded PPX Membrane

Using the methodology described in U.S. Patent Publication No. 2016/0032069 to Sbriglia, a film of polyparaxylylene (PPX-AF4) having a nominal thickness of 1 μm was deposited onto both sides of a blended, extruded, and dried

PTFE tape made generally in accordance with the teachings of U.S. Pat. No. 3,953,566 to Gore by a commercially available vapor deposition process (Specialty Coating Systems, supra). The composite ePPX membrane (tape) was then cut to dimensions of 200 mm×200 mm and placed in the grips of a pantograph type biaxial batch expander equipped with a convection oven. The composite ePPX membrane was subjected to a constant temperature of 350° C. for 300 seconds. The composite ePPX membrane was then simultaneously stretched at an engineering strain rate (ESR) of 100%/second to an extension ratio in the tape machine direction of 4:1 and 4:1 in the tape transverse direction. The expanded composite ePPX membrane was allowed to cool to room temperature (˜22° C.) under restraint of the pantograph biaxial expander grips. After cooling, the expanded composite ePPX membrane was removed from the expander grips. The expanded composite ePPX membrane had a gas liquid bubble point >250 psi (>1.72 MPa). The expanded composite ePPX membrane was then pre-wet with 10 mL of isopropanol. The pre-wetted expanded composite ePPX membrane was then mounted on a filter paper support in a glass vacuum funnel of 90 mm or 150 mm diameter and dosed with 0.06 mg/cm² of an FEP coating solution (fluorinated ethylene propylene 121 D dispersion (The Chemours Company, Wilmington, Del.) diluted in isopropanol by methods known in the art at 0.25 weight percent solids concentration). The FEP coating solution was drawn into the expanded composite ePPX membrane via vacuum at 15 mm hg (˜20 millibar) until no liquid was visible on the surface. The FEP coated ePPX-PTFE membrane was removed from the vacuum funnel, restrained on a hoop, air dried, and then dried in an oven at 360° C. for ten minutes. After oven drying, the ePPX-PTFE membrane was placed face up in an AMICON® stirred cell concentrator/separator (Merck KGaA, supra) and tested for nanofiltration performance as described above. Seventy-five percent (75%) of the feed charge was filtered to a filtrate/permeate, the feed concentration increased to CF=3.76×, the average rejection was 92%, and the average flux was 1 LMH/bar (Table 3). FIG. 6 is an SEM image of the FEP coated membrane.

TABLE 3
Summary of Results

| | | Membrane | | | | |
|---|---|---|---|---|---|---|
| | | Bubble | | | | |
| | | Point | | Percent | Concentration | |
| | | Prior to | Feed | solute | Factor (CF) | |
| | Polymer | polymer | charge | (dye) | (fold increase | Permeance/ |
| | coating on | coating | filtered | rejection | of solute in | Average flux |
| Sample | ePPX | (MPa) | (%) | (%) | retentate) | (L/m²/hour)/bar |
| Example 1 | none | >1.72 | 75 | 0 | 0 | 235 |
| (comparative) | | | | | | |
| Example 2 | n/a¹ | N.D.² | 75 | 60 | N.D. | 0.5 |
| (comparative) | | | | | | |
| Example 3 | PVA | >1.72 | 75 | 57 | 2.7 | 15.4 |
| Example 4 | BPEI - | >1.72 | 75 | 98 | 3.94 | 23.2 |
| | crosslinked | | | | | |
| Example 5 | PVDF | >1.72 | 75 | 90 | 3.7 | 24.7 |
| Example 6 | CYTOP ® | >1.72 | 75 | 88 | 3.6 | 100 |
| | A | | | | | |
| Example 7 | FEP | >1.72 | 75 | 92 | 3.76 | 1 |

¹= commercial 500 MWCO modified polyimide membrane.
²= not determined.

1. An organic solvent nanofiltration (OSN) membrane comprising:
at least one expanded polyparaxylylene (ePPX) membrane having at least one polymer coating thereon; said ePPX membrane having a microstructure comprising nodes, fibrils and pores; said nodes being interconnected by said fibrils and said pores being a void space between said nodes and fibrils, wherein said at least one polymer coating partially occludes said pores, and wherein said organic solvent nanofiltration membrane has an average pore size of about 0.1 nm to about 5 nm.

2. The organic solvent nanofiltration membrane of claim 1, wherein the polymer coating is on one or both sides of the ePPX membrane.

3. The organic solvent nanofiltration membrane of claim 1, wherein the nodes and fibrils are at least partially coated with said polymer coating.

4. The organic solvent nanofiltration membrane of claim 1, wherein the polymer coating is cross-linked.

5. The organic solvent nanofiltration membrane of claim 1, wherein the at least one polymer coating comprises polyethyleneimine (PEI), branched polyethyleneimine (BPEI), polyvinyl alcohol (PVA), polyvinylidene difluoride (PVDF), an amorphous perfluoropolymer, fluorinated ethylene propylene (FEP), and combinations thereof.

6. The organic solvent nanofiltration membrane of claim 5, wherein said at least one polymer coating is a cross-linked polymer coating.

7. The organic solvent nanofiltration membrane of claim 1, wherein said at least one expanded ePPX membrane is a composite ePPX membrane, said composite ePPX membrane comprising the ePPX membrane coupled on one side to at least one additional porous substrate.

8. The organic solvent nanofiltration membrane of claim 7, wherein the additional porous substrate is a porous polyolefin.

9. The organic solvent nanofiltration membrane of claim 8, wherein the additional porous substrate comprises polytetrafluoroethylene (PTFE), modified PTFE or a non-melt processible copolymer or terpolymer comprising tetrafluoroethylene (TFE).

10. The organic solvent nanofiltration membrane of claim 7, wherein the additional porous substrate is expanded PTFE (ePTFE).

11. The organic solvent nanofiltration membrane of claim 1, wherein the organic solvent nanofiltration membrane is a polymer coated ePPX-ePTFE composite membrane.

12. The organic solvent nanofiltration membrane of claim 1, wherein said at least one polymer coating is not polyparaxylylene.

13. The organic solvent nanofiltration membrane of claim 1, wherein the ePPX membrane comprises a polyparaxylylene polymer selected from PPX-N, PPX-AF4, PPX-VT4, or any combination thereof.

14. The organic solvent nanofiltration membrane of claim 1, further comprising at least one porous support.

15. The organic solvent nanofiltration membrane of claim 14, wherein the porous support is a stainless steel mesh, a membrane, an ultrafilter, a nanofilter, a woven or a non-woven made of a cross-linked polyimide, a polyimide, polybenzimidazole (PBI), PTFE, cross-linked polyvinylchloride (PVC), polybutylene terephthalate (PBT), polyethylene terephthalate (PET), polyether ether ketone (PEEK), a polyaramide, inorganic silica, or any combination of copolymer thereof.

16. A system comprising:
a. the organic solvent nanofiltration membrane of any preceding claim; and
b. a solution to be passed through (a) comprising at least one solute having a first molecular weight and at least one organic solvent having a second molecular weight, wherein said second molecular weight is less than said first molecular weight.

17. The nanofiltration system of claim 16, wherein the solute is a pharmaceutical molecule, a petrochemical molecule, a plant extract, a vegetable oil, an animal extract, a cellular extract, a protein, an enzyme, a lipid, an organic catalyst or an inorganic catalyst.

18. An article comprising the organic solvent nanofiltration membrane of claim 1.

19. A filtration device comprising:
a filtration housing comprising:
at least one fluid inlet configured to direct a feed fluid into the filtration housing; and
at least one fluid outlet configured to direct a filtrate from the filtration housing; and
at least one nanofiltration membrane of claim 1.

20. A method for organic solvent nanofiltration comprising:
a) providing
i) the filtration device of claim 17; and
ii) a solution comprising at least one solute having a first molecular weight and at least one organic solvent having a second molecular weight; and
b) passing said solution through the filtration device whereby the percent rejection of the solute is at least 40%, 50%, 60%, 70%, 80%, 90%, 95%, 98% or 99%.

21. The method of claim 20, wherein the solute is a pharmaceutical molecule, a petrochemical molecule, a plant extract, a vegetable oil, an animal extract, a cellular extract, a protein, an enzyme, a lipid, an organic catalyst or an inorganic catalyst.

22. The method of claim 20, wherein the first molecular weight is at least 150 g/mol.

23. The method of claim 20, wherein the second molecular weight is 450 g/mol or less.

24. The method of claim 20, wherein the first molecular weight is greater than said second molecular weight by at least 100 g/mol.
